(19) United States
(12) Patent Application Publication
(10) Pub. No.: US 2018/0234878 A1
(43) Pub. Date: Aug. 16, 2018

(54) MULTI-SUBSCRIBER IDENTITY MODULE (SIM) CALL SETUP

(71) Applicant: QUALCOMM Incorporated, San Diego, CA (US)

(72) Inventors: Abhinav Anand, San Diego, CA (US); Manasi Gandhi, San Diego, CA (US); Shivank Nayak, San Diego, CA (US)

(21) Appl. No.: 15/433,572

(22) Filed: Feb. 15, 2017

(51) Int. Cl. H04W 28/02; H04W 48/16

(52) U.S. Cl. CPC H04W 28/0289; H04W 48/16

(57) ABSTRACT

Apparatus and methods for method for a wireless communication device having a first Subscriber Identity Module (SIM) enabling a first subscription and a second SIM enabling a second subscription to manage communications over the first subscription and the second subscription, including but not limited to determining channel conditions associated with a data Radio Access Technology (RAT) on the first subscription crossing a threshold, searching all cells and bands associated with the data RAT, finding a cell allowed on the second subscription and not allowed on the first subscription, and acquiring the cell on the second subscription.

### BACKGROUND

A wireless communication device, such as a mobile phone device or a smart phone, may include two or more Subscriber Identity Modules (SIMs). Each SIM may correspond to at least one subscription via one or more Radio Access Technologies (RATs). Such a wireless communication device may be a multi-SIM wireless communication device. In a Multi-SIM-Multi-Active (MSMA) wireless communication device, all SIMs may be active at the same time. In a Multi-SIM-Multi-Standby (MSMS) wireless communication device, if any one SIM is active, then the rest of the SIM(s) may be in a standby mode. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), High-Speed Downlink Packet Access (HSDPA), and the like), Global System for Mobile Communications (GSM), Code Division Multiple Access 1×Radio Transmission Technology (1×), General Packet Radio Service (GPRS), Wi-Fi, Personal Communications Service (PCS), and other protocols that may be used in a wireless communications network or a data communications network.

In some configurations, a multi-SIM wireless communication device has at least a first SIM enabling a first subscription and a second SIM enabling a second subscription. In some configurations, the first subscription supports data connectivity via a data RAT (e.g., LTE), and the second subscription also supports data connectivity via the data RAT. Typically, such a multi-SIM wireless communication device attempts to search for cells associated with (allowed by) the data RAT on the first subscription upon detecting that the device is experiencing poor channel conditions on a current cell or is moving outside of the current cell associated with the first subscription. The multi-SIM wireless communication device may attempt the search for a prolonged period of time due to lack of coverage for the data RAT on the first subscription. The multi-SIM wireless communication device does not search for cells associated with (allowed by) the second subscription which also supports the data RAT. As such, the multi-SIM wireless communication device is traditionally unable to leverage potential data RAT coverage by the second subscription when a suitable cell allowed by the first subscription cannot be currently found.

### SUMMARY

In some examples, a method for a wireless communication device having a first Subscriber Identity Module (SIM) enabling a first subscription and a second SIM enabling a second subscription to manage communications over the first subscription and the second subscription, the method includes determining channel conditions associated with a data Radio Access Technology (RAT) on the first subscription crossing a threshold, searching all cells and bands associated with the data RAT, finding a cell allowed on the second subscription and not allowed on the first subscription, and acquiring the cell on the second subscription.

In some examples, the data RAT is Long Term Evolution (LTE).

In some examples, determining the channel conditions associated with the data RAT on the first subscription crossing a threshold includes one or more of: determining signal strength associated with the data RAT on the first subscription crossing a first threshold, determining network congestion associated with the data RAT on the first subscription crossing a second threshold, or determining data throughput on the first subscription is low.

In some examples, determining signal strength associated with the data RAT on the first subscription crossing the first threshold includes determining that Reference Signal Received Power (RSRP) associated with the data RAT on the first subscription crosses a RSRP threshold.

In some examples, determining the network congestion associated with the data RAT on the first subscription crossing a second threshold includes determining that a number of deactivated Hybrid Automatic Repeat Request (HARQ) Identifications (IDs) associated with the data RAT on the first subscription crosses a HARQ threshold.

In some examples, determining the data throughput on the first subscription is low includes determining that another RAT with lower data throughput than that of the data RAT is enabled for data connectivity on the first subscription instead of the data RAT.

In some examples, all the cells and bands associated with the data RAT are searched in response to determining the channel conditions associated with the data RAT on the first subscription crossing the threshold.

In some examples, searching all cells and bands associated with the data RAT includes searching at least one cell or band that is disallowed by the first subscription.

In some examples, finding the cell allowed on the second subscription and not allowed on the first subscription includes: finding a plurality of candidate cells allowed on the second subscription and not allowed on the first subscription, and selecting the cell from the plurality of candidate cells based on signal strength associated with each of the plurality of candidate cells.

In some examples, the method further includes simulating Radio Link Failure (RLF) for the data RAT on the first subscription in response to finding the cell allowed on the second subscription and not allowed on the first subscription.

In some examples, the method further includes determining whether the second subscription successfully acquires the cell.

In some examples, the method further includes performing at least one of Circuit Switch (CS) attach or Location Update (LU) on the first subscription in response to determining that the second subscription successfully acquires the cell.

In some examples, the method further includes attempting to reacquire the data RAT on the first subscription in response to determining that the second subscription does not successfully acquire the cell.

In some examples, the method further includes searching first cells and first bands allowed by the first subscription in response to determining the channel conditions associated with the data RAT on the first subscription crossing the threshold.

In some examples, all the cells and bands associated with the data RAT are searched in response to determining that the first cells and the first bands are not found.

According to some examples, wireless communication device, includes: at least one radio frequency (RF) resource, a processor coupled to the at least one RF resource, configured to connect to a first SIM associated with a first RAT and to a second SIM associated with a second RAT, and configured with processor-executable instructions to: determine channel conditions associated with a data RAT on the first subscription crossing a threshold, search all cells and bands associated with the data RAT, find a cell allowed on the second subscription and not allowed on the first subscription, and acquire the cell on the second subscription, and a memory.

In some examples, the processor determines the channel conditions associated with the data RAT on the first subscription crossing a threshold by one or more of: determining signal strength associated with the data RAT on the first subscription crossing a first threshold, determining network congestion associated with the data RAT on the first subscription crossing a second threshold, or determining data throughput on the first subscription is low.

In some examples, the processor determines signal strength associated with the data RAT on the first subscription crossing the first threshold by determining that RSRP associated with the data RAT on the first subscription crosses a RSRP threshold.

In some examples, the processor determines the network congestion associated with the data RAT on the first subscription crossing a second threshold by determining that a number of deactivated HARQ IDs associated with the data RAT on the first subscription crosses a HARQ threshold.

In some examples, the processor determines the data throughput on the first subscription is low by determining that another RAT with lower data throughput than that of the data RAT is enabled for data connectivity on the first subscription instead of the data RAT.

In some examples, all the cells and bands associated with the data RAT are searched in response to determining the channel conditions associated with the data RAT on the first subscription crossing the threshold.

In some examples, searching all cells and bands associated with the data RAT includes searching at least one cell or band that is disallowed by the first subscription.

In some examples, finding the cell allowed on the second subscription and not allowed on the first subscription includes: finding a plurality of candidate cells allowed on the second subscription and not allowed on the first subscription, and selecting the cell from the plurality of candidate cells based on signal strength associated with each of the plurality of candidate cells.

In some examples, the processor is further configured to simulate RLF for the data RAT on the first subscription in response to finding the cell allowed on the second subscription and not allowed on the first subscription.

In some examples, the processor is further configured to search first cells and first bands allowed by the first subscription in response to determining the channel conditions associated with the data RAT on the first subscription crossing the threshold.

In some examples, a method for a wireless communication device having a first SIM enabling a first subscription and a second SIM enabling a second subscription to manage communications over the first subscription and the second subscription, the method includes: providing data connectivity via a data RAT on the first subscription, determining a cell associated with the data RAT in response to determining poor channel conditions for the data RAT on the first subscription, wherein the cell is allowed by the second subscription and is disallowed by the first subscription, and acquiring the cell on the second subscription to continue the data connectivity via the data RAT on the second subscription.

In some examples, the method further includes enabling voice connectivity on the first subscription.

In some examples, enabling the voice connectivity on the first subscription includes performing at least one of CS attach or LU on the first subscription.

In some examples, the method further includes simulating RLF for the data RAT on the first subscription in response to determining the cell.

In some examples, the method further includes: determining that the cell is allowed by the second subscription, and determining that the cell is disallowed by the first subscription.

### BRIEF DESCRIPTION OF THE DRAWINGS

The accompanying drawings, which are incorporated herein and constitute part of this specification, illustrate exemplary examples of the disclosure, and together with the general description given above and the detailed description given below, serve to explain the features of the various examples.

FIG. 1 is a schematic diagram of a communication system in accordance with various examples.

FIG. 2 is a component block diagram of a wireless communication device according to various examples.

FIG. 3 is a process flowchart diagram illustrating an acquisition method according to various examples.

FIG. 4 is a process flowchart diagram illustrating an acquisition method according to various examples.

FIG. 5 is a table illustrating cell status according to various examples.

FIG. 6 is a process flowchart diagram illustrating an acquisition method according to various examples.

FIG. 7 is a component block diagram of a wireless communication device suitable for use with various examples.

### DETAILED DESCRIPTION

Various examples will be described in detail with reference to the accompanying drawings. Wherever possible, the same reference numbers may be used throughout the drawings to refer to the same or like parts. Different reference numbers may be used to refer to different, same, or like parts. References made to particular examples and implementations are for illustrative purposes, and are not intended to limit the scope of the disclosure or the claims.

A modern communication device, referred to herein as a wireless communication device, User Equipment (UE), or Mobile Station (MS), may include one or more of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such a wireless communication device may include at least one Subscriber Identity Module (SIM), a programmable processor, memory, and circuitry for connecting to two or more mobile communication networks.

A wireless communication device may include one or more SIMs that provide access to one or multiple separate mobile communication networks. The access to mobile communication networks may be facilitated by Radio Access Technologies (RATs). The wireless communication device may be configured to connect to one or more base stations via one or more RATs. Examples of RATs may include, but not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), High-Speed Downlink Packet Access (HSDPA), and the like), Global System for Mobile Communications (GSM), Code Division Multiple Access 1×Radio Transmission Technology (1×), General Packet Radio Service (GPRS), Wi-Fi, Personal Communications Service (PCS), and other protocols that may be used in a wireless communications network or a data communications network. Each RAT may be associated with a subscription or SIM.

A multi-SIM wireless communication device connected to two or more networks with one SIM being active at a given time is a Multi-SIM-Multi-Standby (MSMS) communication device. In one example, the MSMS communication device may be a Dual-SIM-Dual-Standby (DSDS) communication device, which may include two SIMs that may both be active on standby, but one is deactivated when the other one is in use. In another example, the MSMS communication device may be a Triple-SIM-Triple-Standby (TSTS) communication device, which includes three SIMs that may all be active on standby, where two may be deactivated when a third one is in use. In other examples, the MSMS communication device may be other suitable multi-SIM communication devices, with, for example, four or more SIMs, such that when one is in use, the others may be deactivated.

On the other hand, a multi-SIM wireless communication device connected to two or more networks with two or more SIMs being active at a given time may be a MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SIMs may remain active. In other examples, the MSMA communication device may be other suitable multi-SIM communication devices with four or more SIMs, all of which may be active.

Generally, examples described herein are applicable to a MSMS wireless communication device or a MSMA wireless communication device.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless communication device on a network and enable communication services with the network. A SIM as referred to herein may be a physical SIM, virtual SIM, soft SIM, or the like. Because the information stored in a SIM may be used to establish a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters) stored in a particular SIM as the SIM and the communication network, as well as the services and RATs supported by that network, correlate to one another.

Examples described herein relate to enabling seamless high-speed data continuity for a multi-SIM wireless communication device by leveraging data capabilities across multiple subscriptions/SIMs for continued data connectivity. In particular, the wireless communication device may determine poor channel conditions (e.g., low signal strength, low data rate, network congestion, and the like) associated with a data RAT (e.g., LTE) on a first subscription (e.g., on a first SIM). Instead of searching for only the cells/bands associated with the data RAT of the first subscription, the wireless communication device may search for all available cells associated with the data RAT on all device-supported bands irrespective of whether such cells or bands are allowed by the first subscription. In response to finding a suitable cell as a result of the search, the wireless communication device may determine that the cell is not allowed on the first subscription (e.g., due to band mismatch, forbidden cell, and/or the like) and is allowed on a second subscription (e.g., on a second SIM). Upon such determination, the wireless communication device may simulate Radio Link Failure (RLF) on the first subscription and attempt to attach/acquire the cell on the second subscription for data. In response to determining that the second subscription successfully attaches/acquires the cell, the wireless communication device may perform Circuit Switch (CS) attach and/or Location Update (LU) on the first subscription to enable voice on the second subscription. On the other hand, in response to determining that the attach/acquisition is unsuccessful, the wireless communication device may attempt to reacquire the data RAT on the first subscription (e.g., recover from the RLF).

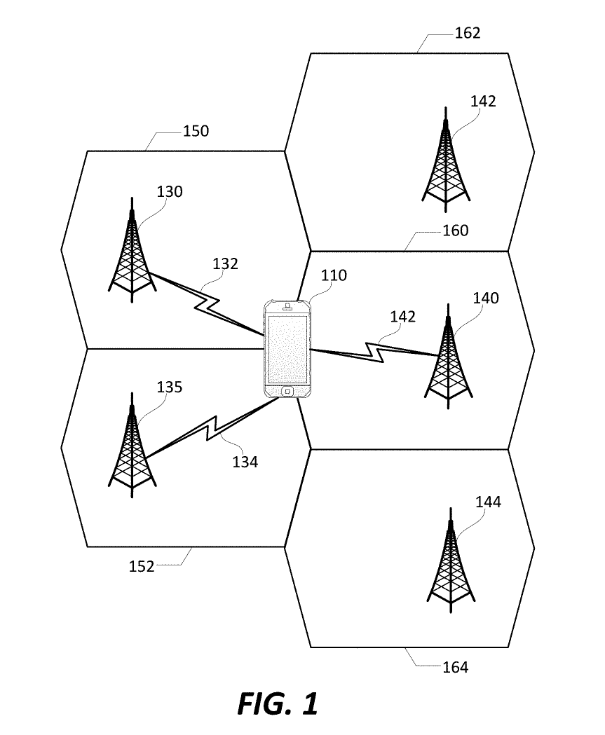

Various examples may be implemented within a communication system 100, an example of which is illustrated in FIG. 1. Referring to FIG. 1, one or more networks (e.g., one or more mobile networks) may each associate with a plurality of cellular base stations for providing data and/or voice services. For instance, a first base station 130 may provide data services in a first serving cell 150. A second base station 140 may provide data services in a second serving cell 160. A third base station 135 may provide voice services in a third serving cell 152. A wireless communication device 110 may be associated with (within effective boundaries of) one or more of the first serving cell 150, the second serving cell 160, or the third serving cell 152. In addition, additional base stations 142 and 144 may provide the data service in serving cells 162 and 164, respectively.

In various examples, the wireless communication device 110 may be configured to access a data network and a voice network by virtue of the multi-SIM and/or multi-mode SIM configuration of the wireless communication device 110. When a SIM corresponding to a subscription is inserted or otherwise provided, the wireless communication device 110 may access the mobile communication network associated with that subscription based on the information stored on the SIM through registrations and call setups.

In some examples, the cells 150, 160, 162, and 164 may be nearby cells associated with the data network that can be found in a cell search by the wireless communication device 110. The cells 150, 160, 162, and 164 may be associated with a data RAT (e.g., one or more of LTE, WCDMA, GSM, or another RAT that supports cellular data) supported by the wireless communication device 110. In the non-limiting example shown in FIG. 1, the first serving cell 150 may be allowed by a first subscription (enabled by a first SIM) of the wireless communication device 110. That is, the first serving cell 150 has a frequency band within the allowable bands of the first subscription, and the first serving cell 150 is not a forbidden cell of the first subscription. One or more of the cells 160, 162, and 164 may be disallowed by the first subscription due to band mismatch, forbidden cell, or the like. For instance, at least the second serving cell 160 may be disallowed by the first subscription. The second serving cell 160 may be allowed by the second subscription. In other words, the second serving cell 160 has a frequency band within the allowable bands of the second subscription, and the second serving cell 160 is not a forbidden cell on the second subscription.

Each of the base stations 130, 140, 142, or 144 may be in communication with the data network over a wired or wireless connection. The third base station 135 may be in communication with the voice network over a wired or wireless connection. The wireless communication device 110 may be in communication with the data network through a first cellular connection 132 to the first base station 130. The first cellular connection 132 may correspond to the data RAT on the first subscription. The wireless communication device 110 can be in communication with the data network through a second cellular connection 142 to the second base station 140. The second cellular connection 142 may correspond to the data RAT on the second subscription. The wireless communication device 110 may be in communication with the voice network through a third cellular connection 134 to the third base station 135. The third cellular connection 134 may correspond to the voice RAT on the first subscription.

Each of the first cellular connection 132 and second cellular connection 142 may be a two-way wireless communication link that supports data connectivity via the data RAT. For example, the data RAT may be one or more of LTE, WCDMA, GSM, or another RAT that supports cellular data. The wireless communication device 110 may be experiencing deteriorating channel conditions with respect to the first cellular connection 132 (e.g., with respect to the first serving cell 150). The third cellular connection 134 may be a two-way wireless communication link that supports voice connectivity via the voice RAT. For example, the voice RAT may be one or more of CS WCDMA, CS GSM, or another RAT that supports voice. As further shown in a non-limiting example, the first subscription of the wireless communication device 110 may support one or more of CDMA, GSM, WCDMA, or LTE, and the second subscription of the wireless communication device 110 may support one or more of GSM, WCDMA, or LTE.

Each of the base stations 130, 135, 140, 142, or 144 may include at least one antenna group or transmission station located in the same or different areas. The at least one antenna group or transmission station may be associated with signal transmission and reception. Each of the base stations 130, 135, 140, 142, or 144 may include one or more processors, modulators, multiplexers, demodulators, demultiplexers, antennas, and the like for performing the functions described herein. In some examples, each of the base stations 130, 135, 140, 142, or 144 may be an access point, Node B, evolved Node B (eNodeB or eNB), base transceiver station (BTS), or the like.

In some examples, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”). In some examples, the wireless communication device 110 may establish a wireless connection with a wireless access point (not shown), such as over a Wi-Fi connection. The wireless access point may be configured to connect to the Internet or another network over a wired connection.

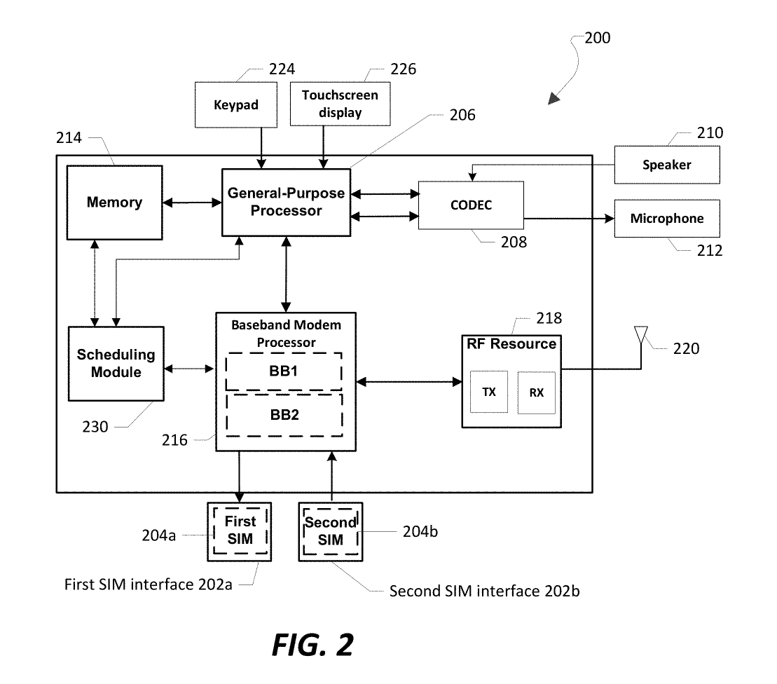

FIG. 2 is a functional block diagram of a wireless communication device 200 suitable for implementing various examples. The wireless communication device 200 may be the wireless communication device 110 as described with reference to FIG. 1. Referring to FIGS. 1-2, the wireless communication device 200 may include a first SIM interface 202a, which may receive or otherwise include a first SIM 204a that is associated with the first subscription. The wireless communication device 200 may include a second SIM interface 202b, which may receive or otherwise include a second SIM 204b that is associated with the second subscription.

A SIM (e.g., the first SIM 204a, the second SIM 204b, or the like) in various examples may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. However, a soft SIM or a virtual SIM may be implemented within a portion of memory of the wireless communication device 200, and thus need not be a separate or removable circuit, chip, or card.

A SIM used in various examples may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home Public Land Mobile Network (HPLMN) code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may include a non-transitory processor-readable storage medium that stores processor-executable instructions. For example, the instructions may include routing communication data relating to the first or second SIM though a corresponding baseband-RF resource chain. The memory 214 may include any suitable internal or external device for storing software and data. Examples of the memory 214 may include, but are not limited to, RAM, ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the first SIM 204a, the second SIM 204b, and/or the like) in the wireless communication device 200 may be associated with at least one baseband-RF resource chain. A baseband-RF resource chain may include the baseband modem processor 216, which may perform baseband/modem functions for communications over the SIMs 204a and 204b. The baseband modem processor 216 may include or may be otherwise coupled to one or more amplifiers and radios, referred to generally herein as RF resource 218 or RF chain.

The RF resource 218 may include at least one transceiver that perform transmit/receive functions for the associated SIMs 204a and 204b of the wireless communication device 200. The RF resource 218 may include separate transmit and receive circuitries, or may include a transceiver that combines transmitter and receiver functions. The RF resource 218 may be coupled to a wireless antenna 220. The RF resource 218 may also be coupled to the baseband modem processor 216.

The examples described herein are applicable to the SIMs 204a and 204b sharing a common set of RF resource (particularly, the RF resource 218), such as in a MSMS device. Examples described herein are applicable to each of the SIMs 204a and 204b having a separate RF resource, such as in a MSMA device.

In some examples, the general-purpose processor 206, the memory 214, the baseband modem processor 216, and the RF resource 218 may be included in the wireless communication device 200 as a system-on-chip. In some examples, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communication between them.

The wireless communication device 200 may include an acquisition module 230. The acquisition module 230 may configure the RF resource 218 to communicate over the first subscription (the first SIM 204a) and the second subscription (the second SIM 204b) in the manner described. For instance, the acquisition module 230 may configure the RF resource 218 to perform cell search for cells associated with the data RAT (e.g., the cells 150, 160, 162, 164, or the like) and/or for cells associated with the voice RAT (e.g., the third serving cell 152). The acquisition module 230 may select a suitable cell and configure the RF resource 218 to acquire the cell in the manner described.

In some examples, the acquisition module 230 may be implemented within the baseband modem processor 216. For example, the acquisition module 230 may be implemented as a software application stored within the memory 214 and executed by the baseband modem processor 216. The general-purpose processor 206 may manage application processes and the acquisition module 230 may facilitate data and voice connectivity through cell search and acquisition procedures described herein. Thus, the acquisition module 230 may be coupled to the general-purpose processor 206 to provide data connectivity and voice connectivity to the applications executed by the general-purpose processor 206. In other examples, the acquisition module 230 may be implemented with the general-purpose processor 206. Accordingly, such examples can be implemented with minimal additional hardware costs. However, other examples relate to systems and processes implemented with dedicated hardware specifically configured for performing operations described herein with respect to the acquisition module 230. For example, the acquisition module 230 may be implemented as a separate processing component (i.e., separate from the baseband modem processor 216). In such examples, the acquisition module 230 may be coupled to one or more of the memory 214, the general-purpose processor 206, the baseband processor 216, or the RF resource 218 for performing the function described herein.

Hardware and/or software for the functions may be incorporated in the wireless communication device 200 during manufacturing, for example, as a part of a configuration of an original equipment manufacturer (OEM) of the wireless communication device 200. In further examples, such hardware and/or software may be added to the wireless communication device 200 post-manufacture, such as by installing one or more hardware devices and/or software applications onto the wireless communication device 200.

In some examples, the wireless communication device 200 may include, among other things, additional SIM cards, SIM interfaces, at least another RF resource associated with the additional SIM cards, and additional antennas for connecting to additional networks.

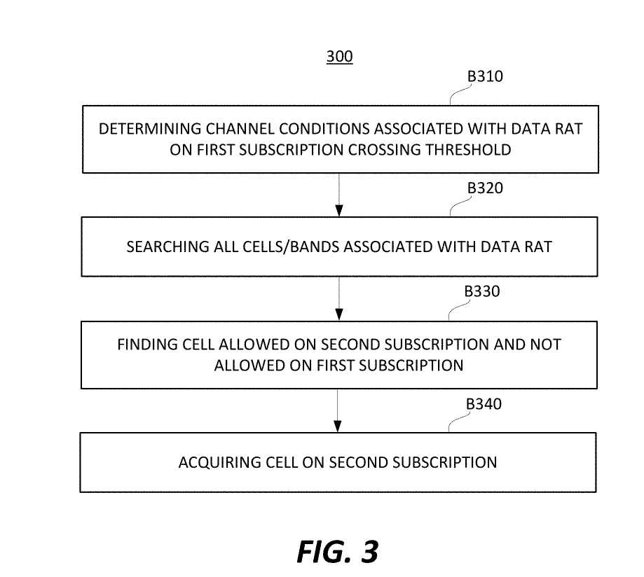

FIG. 3 is a process flowchart diagram illustrating an acquisition method 300 according to various examples. Referring to FIGS. 1-3, the acquisition module 230 may perform the acquisition method 300 in some examples. The acquisition method 300 is concerned with scanning all device-supported bands for all cells associated with the data RAT (e.g., LTE) in response to detecting poor channel conditions for the data RAT on the first subscription, on the first serving cell 150. Upon finding a cell that is allowed on the second subscription and disallowed on the first subscription, the acquisition module 230 may attempt to acquire that cell on the second subscription.

At block B310, the acquisition module 230 may determine channel conditions associated with the data RAT on the first subscription crossing a threshold. The data RAT on the first subscription may be currently camping on the first serving cell 150 at block B310. The channel conditions crossing the threshold indicates poor channel conditions with respect to the first cellular connection 132. The acquisition module 230 may configure the RF resource 218 to measure the channel conditions. Examples of channel condition measurements include, but not limited to, signal strength, network congestion, data throughput, network reject, and the like. In some configurations, the acquisition module 230 may determine one or more of: signal strength associated with the data RAT on the first subscription crossing a first threshold, network congestion associated with the data RAT on the first subscription crossing a second threshold or data throughput on the first subscription is low, or network reject. In some configurations, the acquisition module 230 may determine that the wireless communication device 200 is going Out-Of-Service (OOS) of the first serving cell 150.

At block B320, the acquisition module 230 may configure the RF resource 218 to search all cells and bands associated with the data RAT. That is, all data RAT bands (e.g., all LTE bands) supported by the wireless communication device 200 may be searched irrespective of whether the first subscription allows or disallows each band due to band match/mismatch. Similarly, all data RAT cells (e.g., all LTE cells) may be searched for irrespective of whether the first subscription allows or disallows (e.g., forbids) each cell. In some examples, the acquisition module 230 may configure the RF resource 218 to search at least one band or search for at least one cell that is disallowed by the first subscription. The search at block B320 may be performed in response to block B310. Thus, instead of searching for only the bands/cells allowed by the first subscription, all bands/cells may be searched upon determination of the deteriorating channel conditions on the first serving cell 150.

At block B330, the acquisition module 230 may find a cell allowed on the second subscription and not allowed on the first subscription. Illustrating with a non-limiting example, the acquisition module 230 may configure the RF resource 218 to search all LTE bands and finds LTE cells 160, 162, and 164. At least the second serving cell 160 is forbidden by the first subscription or is associated with a mismatched band relative to the first subscription. The second subscription allows the second serving cell 160. Thus, the second serving cell 160 may be the cell that is allowed on the second subscription and not allowed on the first subscription.

At block B340, the acquisition module 230 may configure the RF resource 218 to acquire the cell (e.g., the second serving cell 160) on the second subscription. Acquiring the cell refers to performing one or more of initial attach, acquisition procedure, or registration procedure using information stored in the second SIM 204b. The data connectivity may thusly be provided by the second subscription instead of the first subscription as a result.

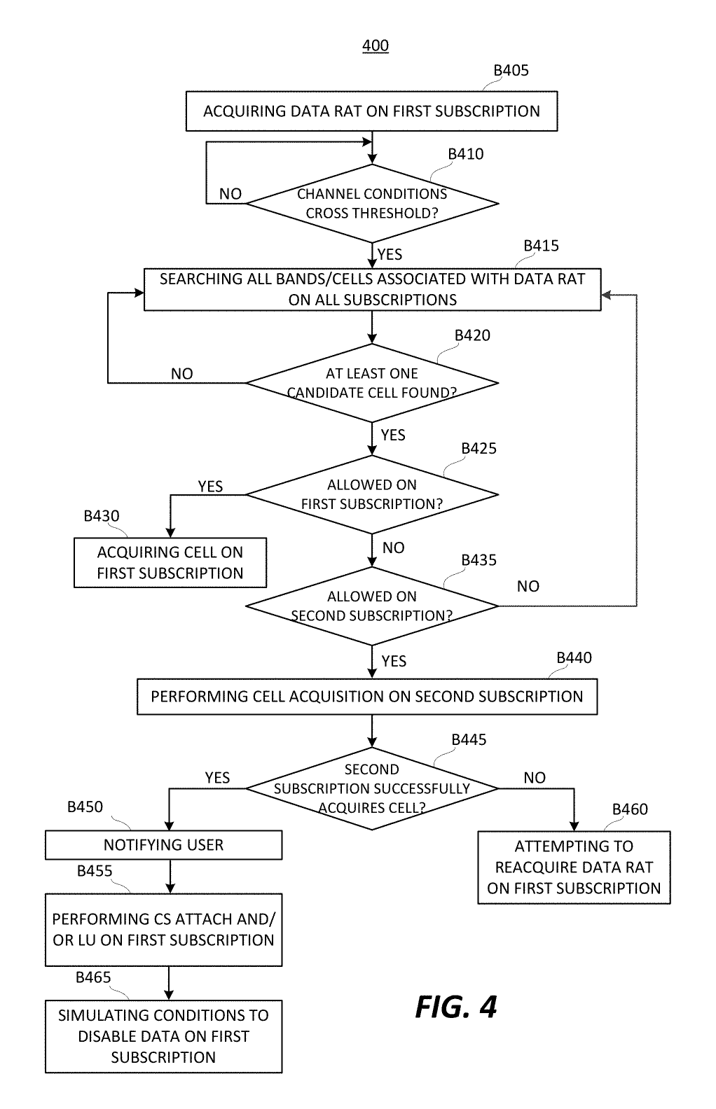

FIG. 4 is a process flowchart diagram illustrating an acquisition method 400 according to various examples. Referring to FIGS. 1-4, the acquisition method 400 may be a particular implementation of the acquisition method 300. Thus, one or more of blocks B405-B460 correspond to one or more of blocks B310-B340. The acquisition module 230 may perform the acquisition method 400 in some examples.

At block B405, the acquisition module 230 may configure the RF resource 218 to acquire the data RAT (e.g., LTE) on the first subscription. The first subscription may be a preferred subscription for data services, for example, due to favorable data throughput, cell coverage, fees, and/or the like. The first subscription may be camped on the first serving cell 150 which provides data.

At block B410, the acquisition module 230 may determine whether channel conditions of the data RAT on the first subscription (e.g., with respect to the first serving cell 150) crosses the threshold. For instance, the acquisition module 230 may determine the channel conditions based on one or more of the signal strength, network congestion, data throughput, network reject, or the like in the manner described. In response to determining that the channel conditions do not cross the threshold (B410:NO), the method 400 returns to block B410.

With respect to signal strength, the acquisition module 230 may determine that Reference Signal Received Power (RSRP) associated with the first serving cell 150 crosses a RSRP threshold. Other parameters such as, but not limited to, Received Signal Strength Indicator (RSSI), Reference Signal Received Quality (RSRQ), or the like can be likewise implemented.

With respect to network congestion, the acquisition module 230 may determine that a number of deactivated Hybrid Automatic Repeat Request (HARQ) Identifications (IDs) associated with the first serving cell 150 crosses a HARQ threshold. The data network may determine one or more HARQ IDs (out of 8 total HARD IDs) to deactivate corresponding to congestion measured by the data network and/or the first serving cell 150. The wireless communication device 200 may receive the deactivated HARD IDs from the data network and/or the first serving cell 150. Examples of the HARQ threshold include, but not limited to, 3, 4, 5, 6, or the like.

With respect to data throughput, the acquisition module 230 may determine that another RAT (e.g., WCDMA, GSM, or the like) with lower data throughput than that of the data RAT (e.g., LTE) is enabled or otherwise used for data connectivity by the data RAT on the first subscription instead of the data RAT.

The loss of data services on the first subscription, which may initiate search of all bands/cells associated with the data RAT, including the bands/cells allowed on the second subscription but not the first subscription, may be due to various network reject scenarios, including temporary or permanent failures, RLF/OOS, idle mode reselection from LTE to 3G on the first subscription, Single Radio Voice Call Continuity (SRVCC) Hand Over (HO) from LTE to 3G on the first subscription, or the like.

In some examples, the data network on the first subscription may reject the wireless communication device 200 with a temporary or permanent failure. For instance, the data network on the first subscription may initiate detach with the wireless communication device 200 due to one or more of Evolved Packet System (EPS) services not allowed, non-EPS services not allowed, IMSI unknown, PLMN not allowed, Tracking Area (TA) not allowed, or the like. In some examples, the data network on the first subscription may reject the attach of the wireless communication device 200 due to EPS services not allowed, Non-EPS services not allowed, illegal UE, PLMN not allowed, TA not allowed, and/or the like. In some examples, the data network on the first subscription may reject the Tracking Area Update (TAU) of the wireless communication device 200 due to Network Load Balancing, EPS services not allowed, Non-EPS services not allowed, TA not allowed, and/or the like. In some examples, the data network on the first subscription may reject the service on the first subscription of the wireless communication device 200 due to EPS services not allowed, Non-EPS services not allowed, PLMN not allowed, and/or the like.

In some examples, the wireless communication device 200 may lose the data service (e.g., LTE service) on the first subscription via RLF or OOS. RLF triggers include, but not limited to, low RSRP, poor signal quality that fails channel decode, or the like.

In some examples, the wireless communication device 200 may perform Idle Mode reselection from LTE to 3G on the first subscription based on signal strength. Cell reselection criteria include, but not limited to, Cell selection RX level value (Srxlev) measured in dB, Cell selection quality value (Squal) measured in dB, or the like. Cell reselection properties include, but not limited to, ThresholdLow, ThresholdHigh and Cell priority, which are obtained from LTE SIBs, such as, but not limited to, LTE SIB6 (for UMTS), LTE SIB7 (for GSM), LTE SIB8 (for CDMA), or the like.

In some examples, the wireless communication device 200 may perform SRVCC HO from LTE to 3G on the first subscription. Other possible movement options from 4G to 3G include Handover, Redirection, or the like. HO and Redirection may be based on neighbor cell measurements of 3G target cells determined by the wireless communication device 200 when on LTE serving cells. This may be based on Serving and Target Cells RSRP and threshold criteria. SRVCC is a HO process of a voice call being handed over to 3G (UMTS, GSM or 1×RTT) that originally started as a VoLTE Call over the IMS LTE network. This may also be based on Serving and Target Cells RSRP and threshold criteria. For SRVCC, HO and Redirection are Connected mode procedures, and the search for LTE on the second subscription can be initiated after call ends on the first subscription.

On the other hand, in response to determining that the channel conditions cross the threshold (B410:YES), the acquisition module 230 may search all bands/cells associated with the data RAT, at block B415. As described, instead of searching for only the cells/bands associated with the data RAT of the first subscription, the wireless communication device 200 may search for all available cells associated with the data RAT on all device-supported bands (e.g., on all subscriptions that support data) irrespective of whether such cells or bands are allowed by the first subscription.

At block B420, the acquisition module 230 may determine whether at least one candidate cell is found. Illustrating with a non-limiting example, the cells 160, 162, and 164 that are associated with the data RAT may be the candidate cells. In response to determining that no candidate cell is not found (B420:NO), the method 400 returns to block B415. On the other hand, in response to determining that the at least one candidate cell is found (B420:YES), the acquisition module 230 may determine whether one or more of the at least one candidate cell are allowed on the first subscription, at block B425.

In response to determining that one or more of the at least one candidate cell is allowed on the first subscription (B425:YES), the acquisition module 230 may configure the first subscription to acquire the cell allowed on the first subscription, at block B430. In some examples, the channel conditions associated with the cell allowed on the first subscription may have to be sufficiently favorable to avoid a Ping-Pong effect. That is, a channel condition threshold (such as, but not limited to, those described with respect to blocks B310 and B420) may be set, such that upon determination that the channel conditions of the cell allowed on the first subscription exceed (e.g., performs better than) the conditions indicated by the threshold, the first subscription may acquire that cell. Exemplary measurements of channel conditions include, but not limited to, the signal strength, network congestion, data throughput, or the like. Otherwise, the method 400 proceeds to B435 upon determination that none of the candidate cell(s) allowed on the first subscription may perform better than the channel condition threshold. In addition, in response to determining that the acquisition for all the candidate cells allowed by the first subscription is unsuccessful on the first subscriptions, the method 400 proceeds to block B435. In the instances in which two or more candidate cells allowed on the first subscription pass the channel condition threshold for acquisition, the candidate cell with better/best channel condition indicators (e.g., better/best the signal strength, better/best network congestion, better/best data throughput, or the like) may be selected for acquisition by the first subscription at block B430. In some examples, block B410 may be performed in response to block B430.

In response to determining that the at least one candidate cell is not allowed on the first subscription (B425:NO), the acquisition module 230 may determine whether the at least one cell found is allowed on the second subscription at block B435. In response to determining that none of the at least one candidate cell is allowed on the second subscription (B435:NO), the method 400 proceeds to block B415.

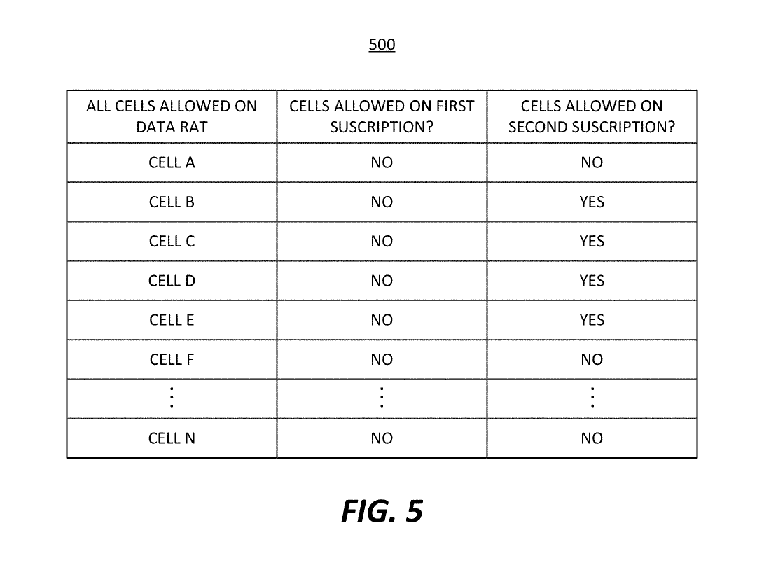

To further illustrate blocks B425 and B435, FIG. 5 shows a table illustrating cell status relative to the first and second subscriptions according to some non-limiting examples. Referring to FIGS. 1-5, the wireless communication device 200 may have found CELL A, CELL B, . . . , CELL N as the candidate cells during the search at block B415. None of the candidate cells may be allowed on the first subscription, resulting in B425:NO. CELL B, CELL C, CELL D, CELL E, or the like may be allowed on the second subscription. Therefore, the second subscription may perform cell acquisition on one or more of CELL B, CELL C, CELL D, and CELL E, for example, at block B440. The acquisition module 230 may select one of the candidate cells based on signal strength or other channel condition indicators in the manner described.

At block B440, in response to determining that one or more of the at least one candidate cell is allowed on the second subscription (B435:YES), the acquisition module 230 may configure the RF resource 218 to perform cell acquisition on the second subscription for the candidate cell allowed on the second subscription. In some examples, the channel conditions associated with the cell allowed on the second subscription may have to be sufficiently favorable to avoid a Ping-Pong effect. That is, a channel condition threshold (such as, but not limited to, those described with respect to blocks B310 and B420) may be set, such that upon determination that the channel conditions of the cell allowed on the second subscription exceed the conditions indicated by the threshold, the second subscription may acquire that cell. Exemplary measurements of channel conditions include, but not limited to, the signal strength, network congestion, data throughput, or the like. Otherwise, the method 400 proceeds to B415 upon determination that none of the candidate cell(s) allowed on the second subscription may perform better than the channel condition threshold. In the instances in which two or more cells allowed on the second subscription pass the channel condition threshold for acquisition, the candidate cell with better/best channel condition indicators (e.g., better/best the signal strength, better/best network congestion, better/best data throughput, or the like) may be selected for acquisition at block B440.

At block B445, the acquisition module 230 may determine whether the second subscription successfully acquires the candidate cell allowed on the second subscription. In response to determining that the second subscription successfully acquires the cell allowed on the second subscription (B445:YES), the wireless communication device 200 may notify the user of the wireless communication device 200 that the second subscription is providing the data services instead of the first subscription, at block B450. The subscriptions may differ in one or more of the data throughput, cell coverage, fees, or the like. Thus, in some configurations, the user of the wireless communication device 200 may be notified of the switch in data provider. For instance, the acquisition module 230 and/or the modem processor 216 may send a notification signal to the general-purpose processor 206 indicating that the preferred data subscription is switched from the first SIM 204a (e.g., the first subscription) to the second SIM 204b (e.g., the second subscription). The general-purpose processor 206 may cause a user interface (e.g., the touchscreen display 226, the speaker 210, or the like) to notify that the preferred data provider is switched to the second subscription. In some examples, the user interface may receive user input relative to whether the switch is permitted. In response to receiving user input corresponding to the user's approval of the switch, block B455 may be performed. On the other hand, in response to receiving user input relative to the user's disapproval of the switch, the method 400 may return to block B410 or B415, or block B460 may be performed.

In some examples, the user interface may receive user input relative to whether the switch is permitted in response to B435:YES and before B440. In response to receiving user input indicating that the user permits the switch, block B440 may be executed. On the other hand, in response to receiving user input indicating that the user does not permit the switch, block B440-B455 and B465 are omitted and block B460 is performed.

At block B455, the acquisition module 230 may configure the RF resource 218 to perform CS attach and/or LU on the first subscription. Illustrating with a non-limiting example, the acquisition module 230 may attempt to perform CS attach and/or LU on the third serving cell 152, which supports the voice RAT (e.g., GSM, WCDMA, or the like) of the first subscription.

At block B465, the acquisition module 230 may simulate conditions to disable data on the first subscription. For instance, the Radio Resource Control (RRC) layer implemented by the acquisition module 230 may set an RSRP threshold that is greater than the RSRP associated with a cell currently camped on by the data RAT of the first subscription. The RRC layer may notify the RSRP threshold to the lower layers. The lower layers may trigger a Radio Link Failure (RLF) in response to determining that the RSRP associated with the current cell is lower than the RSRP threshold. In other words, the RRC layer may set a threshold that the current cell is known to not have met to trigger RLF and may indicate to all protocol layers that the wireless communication device 200 is no longer operating on the data RAT (e.g., LTE) anymore on the first subscription. The first subscription may be operating on a data RAT with lower data throughput (e.g., 3G). In some examples, the acquisition module 230 may implement a module or entity other than the RRC for the operations described herein.

In some examples, the acquisition module 230 may determine that the first subscription has not been registered in response to determining CS Attach/LU request. In such examples, the acquisition module 230 may register CS attach/LU if allowed (e.g., voice cell not forbidden, voice cell not blocked, and/or the like) and forego registering the data RAT on the first subscription (e.g., forego camping on a data cell).

In some scenarios in which the data network rejects the wireless communication device 200 (e.g., due to SRVCC/HO/IRAT/Attach Reject), the wireless communication device 200 may have already exited LTE or 4G to camp on 3G. In such scenarios, simulating RLF on 4G or LTE may not be needed given that the wireless communication device 200 has already left the LTE RAT.

On the other hand, in response to determining that the second subscription does not successfully acquire the cell allowed on the second subscription (B445:NO), the acquisition module 230 may attempt to reacquire the data RAT on the first subscription at block B460. For instance, reacquiring the data RAT may refer to reverse the RLF or recover from the RLF such that the acquisition module 230 may configure the RF resource 218 to scan for cells/bands allowed by the first subscription. Alternatively, in response to determining that the second subscription does not successfully acquire the cell allowed on the second subscription (B445:NO), the method 400 proceeds to block B415.

In other examples, instead of searching all bands/cells associated with the data RAT at block B415, the acquisition module 230 may configure the RF resource 218 to search first cells and first bands allowed by the first subscription in response to determining the channel conditions associated with the data RAT on the first subscription crossing the threshold (B410:YES). Upon failure to find a first cell in the first bands, all cells/bands associated with the data RAT may be searched (such as, but not limited to, block B415). The method 400 then proceeds from B415. In such examples, blocks B425 and B430 may be omitted, and block B435 may follow B420:YES. The data network and/or the first serving cell 150 may determine that the wireless communication device is OOS and send an indicator for network-triggered RLF.

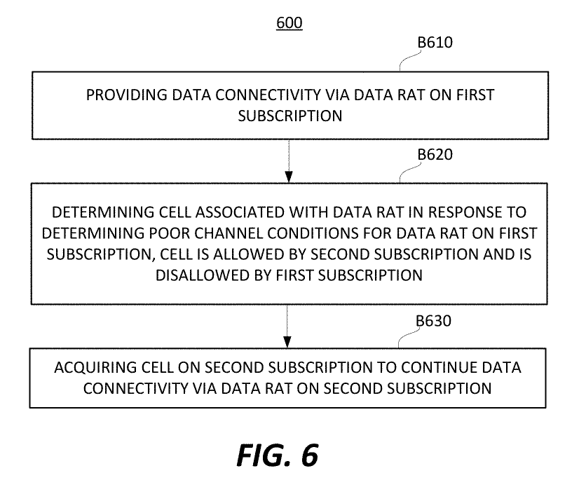

FIG. 6 is a process flowchart diagram illustrating an acquisition method 600 according to various examples. Referring to FIGS. 1-6, one or more of blocks B610-B630 correspond to one or more of blocks B405-B460 and/or one or more of blocks B310-B340. The acquisition module 230 may perform the acquisition method 600 in some examples.

At block B610, the acquisition module 230 may provide data connectivity via a data RAT on the first subscription. Illustrating with a non-limiting example, the first subscription may camp on the first serving cell 150 for data connectivity. The acquisition module 230 may communicably couple to the general-purpose processor 206 to determine or obtain data preferences for applications executed by the general-purpose processor 206 and provide data connectivity for the applications.

At block B620, the acquisition module 230 may determine (e.g., find through a search) a cell associated with the data RAT in response to determining poor channel conditions for the data RAT on the first subscription. The cell is allowed by the second subscription and is disallowed by the first subscription in the manner described herein.

At block B630, the acquisition module 230 may configure the RF resource 218 to acquire the cell on the second subscription to continue the data connectivity via the data RAT on the second subscription. Particularly, the acquisition module 230 and/or the modem processor 216 may route the data received and/or transmitted by the RF resource 218 to or from the general-purpose processor 206.

While in the non-limiting example set forth herein the data capabilities of the second SIM 204b (e.g., preferred data subscription) is leveraged upon detecting that data channel conditions of the first SIM 204a deteriorate, the data capabilities of the first SIM 204a may be leveraged upon detecting that data channel conditions of the second SIM 204b deteriorate.

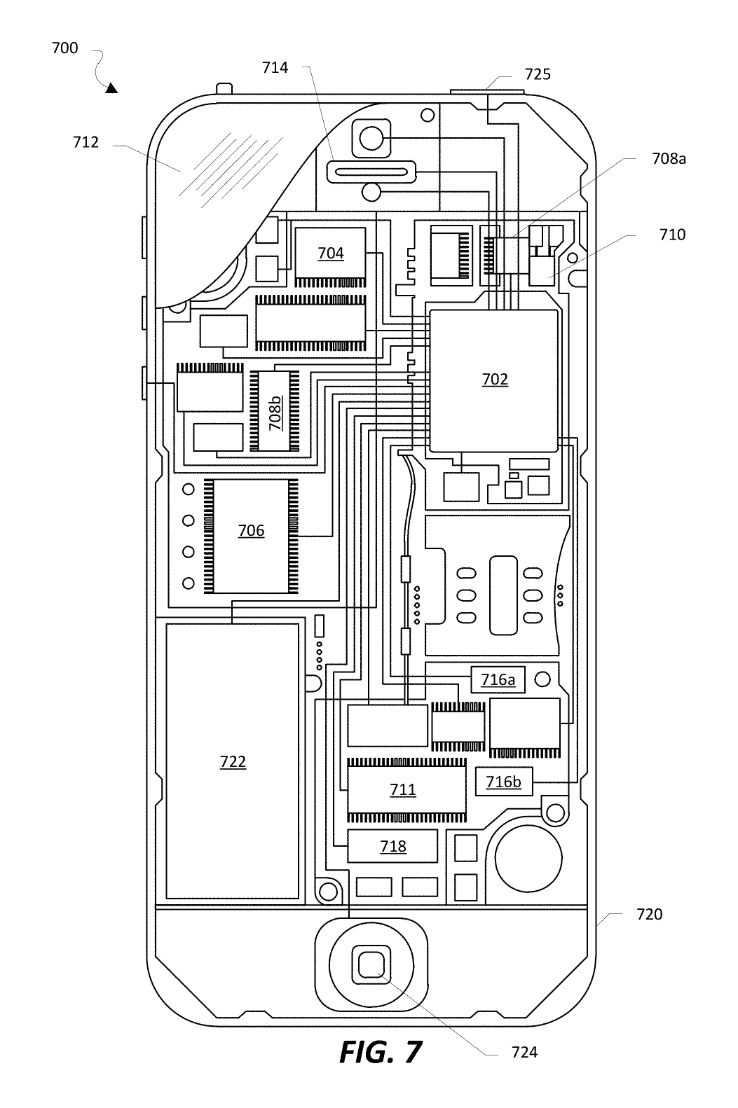

The various examples may be implemented in any of a variety of wireless communication devices 110 and 200, an example of which is illustrated in FIG. 7, as wireless communication device 700. As such, the wireless communication device 700 may implement the process and/or the apparatus of FIGS. 1-6, as described herein.

With reference to FIGS. 1-7, the wireless communication device 700 may include a processor 702 coupled to a touchscreen controller 704 and an internal memory 706. The processor 702 may be one or more multi-core integrated circuits designated for general or specific processing tasks. The memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the wireless communication device 700 need not have touch screen capability.

The wireless communication device 700 may have one or more cellular network transceivers 708a, 708b coupled to the processor 702 and to at least one antenna 710 and adapted for sending and receiving cellular communications. The transceivers 708a, 708b and antenna 710 may be used with the above-mentioned circuitry to implement the various example methods. The cellular network transceivers 708a, 708b may be the RF resource 218. The antenna 710 may be the antenna 220. The wireless communication device 700 may include two or more SIM cards 716a, 716b, corresponding to The first SIM 204a (first SIM 401) and The second SIM 204b(second SIM 402), coupled to the transceivers 708a, 708b and/or the processor 702. The wireless communication device 700 may include a cellular network wireless modem chip 711 (e.g., the baseband modem processor 216) that enables communication via at least one cellular network and is coupled to the processor 702.

The wireless communication device 700 may include a peripheral device connection interface 718 coupled to the processor 702. The peripheral device connection interface 718 may be singularly adapted to accept one type of connection, or multiply adapted to accept various types of physical and communication connections, common or proprietary, such as USB, FireWire, Thunderbolt, or PCIe. The peripheral device connection interface 718 may also be coupled to a similarly adapted peripheral device connection port (not shown).

The wireless communication device 700 may also include speakers 714 for providing audio outputs. The wireless communication device 700 may also include a housing 720, constructed of a plastic, metal, or a combination of materials, for containing all or some of the components discussed herein. The wireless communication device 700 may include a power source 722 coupled to the processor 702, such as a disposable or rechargeable battery. The rechargeable battery may also be coupled to a peripheral device connection port (not shown) to receive a charging current from a source external to the wireless communication device 700. The wireless communication device 700 may also include a physical button 724 for receiving user inputs. The wireless communication device 700 may also include a power button 726 for turning the wireless communication device 700 on and off.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

1. A method for a wireless communication device including a first Subscriber Identity Module (SIM) enabling a first subscription and a second SIM enabling a second subscription to manage communications associated with the first subscription and the second subscription, the method comprising:
determining that channel conditions associated with the first subscription exceed a threshold;
searching for cells associated with a data Radio Access Technology (RAT), wherein the searching comprises searching for cells that are allowed by the second subscription associated with the second SIM and forbidden by the first subscription associated with the first SIM;
finding a cell allowed by the second subscription and forbidden by the first subscription, wherein cells of the first subscription and the second subscription are associated with the data RAT; and
acquiring the cell allowed by the second subscription.

2. The method of claim 1, wherein the data RAT follows a Long Term Evolution (LTE) protocol.

3. The method of claim 1, wherein determining the channel conditions associated with the first subscription comprise at least one from the group consisting of determining a signal strength associated with the first subscription has crossed a first threshold, determining network congestion associated with the first subscription has crossed a second threshold, and determining data throughput associated with the first subscription is low.

4. The method of claim 3, wherein determining the signal strength associated with the first subscription comprises determining that a Reference Signal Received Power (RSRP) associated with the first subscription has crossed a RSRP threshold.

5. The method of claim 3, wherein determining the network congestion associated with the first subscription comprises determining that a number of deactivated Hybrid Automatic Repeat Request (HARQ) Identifications (IDs) associated with the first subscription has crossed a HARQ threshold.

6. (canceled)

7. The method of claim 1, wherein all the cells associated with the data RAT are searched in response to determining the channel conditions associated with the first subscription exceeded the threshold.

8. (canceled)

9. The method of claim 1, wherein finding the cell allowed by the second subscription and forbidden by the first subscription comprises:
finding a plurality of candidate cells allowed by the second subscription and forbidden by the first subscription; and
selecting the cell from the plurality of candidate cells based on a signal strength associated with each of the plurality of candidate cells.

10. The method of claim 1, further comprising simulating a Radio Link Failure (RLF) for the first subscription in response to finding the cell allowed by the second subscription and forbidden by the first subscription.

11. The method of claim 1, further comprising determining whether the wireless communication device successfully acquires the cell.

12. The method of claim 11, further comprising performing at least one of Circuit Switch (CS) attach or Location Update (LU) for the first subscription in response to determining that the wireless communication device successfully acquires the cell.

13. The method of claim 11, further comprising attempting to reacquire a cell associated with the first subscription in response to determining that the wireless communication device does not successfully acquire the cell.

14. (canceled)

15. (canceled)

16. A wireless communication device, comprising:
at least one radio frequency (RF) resource;
a first Subscriber Identity Module (SIM) enabling a first subscription associated with a data Radio Access Technology (RAT);
a second SIM enabling a second subscription associated with the data RAT;
a processor coupled to the at least one RF resource; and
a memory storing instructions that, when executed by the processor cause the wireless communication device to:
determine that channel conditions associated with the first subscription exceed a threshold;
search for cells associated with the data RAT wherein the search comprises a search for cells allowed by the second subscription associated with the second SIM and forbidden by the first subscription associated with the first SIM;
find a cell allowed by the second subscription and forbidden by the first subscription, wherein cells of the first subscription and the second subscription are associated with the data RAT; and
acquire the cell allowed by the second subscription.

17. The wireless communication device of claim 16, wherein execution of the instructions to determine the channel conditions causes the wireless communication device to determine at least one from the group consisting of:
a signal strength associated with the first subscription has crossed a first threshold, a network congestion associated with the first subscription has crossed a second threshold, and a data throughput associated with the first subscription is low.

18. The wireless communication device of claim 17, wherein execution of the instructions to determine the signal strength associated with the first subscription causes the wireless communication device to further:
determine that a Reference Signal Received Power (RSRP) associated with the first subscription has crossed a RSRP threshold.

19. The wireless communication device of claim 17, wherein execution of the instructions to determine the network congestion associated with the first subscription causes the wireless communication device to further:
determine that a number of deactivated Hybrid Automatic Repeat Request (HARQ) Identifications (IDs) associated with the first subscription has crossed a HARQ threshold.

20. (canceled)

21. The wireless communication device of claim 16, wherein all the cells associated with the data RAT are searched in response to determining the channel conditions associated with the data RAT on the first subscription exceeded the threshold.

22. (canceled)

23. The wireless communication device of claim 16, wherein execution of the instructions to find the cell allowed by the second subscription and forbidden by the first subscription causes the wireless communication device to further:
find a plurality of candidate cells allowed by the second subscription and forbidden by the first subscription; and
select the cell from the plurality of candidate cells based on a signal strength associated with each of the plurality of candidate cells.

24. The wireless communication device of claim 16, wherein execution of the instructions causes the wireless communication device to further:
simulate a Radio Link Failure (RLF) the first subscription in response to finding the cell allowed by the second subscription and forbidden by the first subscription.

25. (canceled)

26. A method for a wireless communication device having a first Subscriber Identity Module (SIM) enabling a first subscription and a second SIM enabling a second subscription to manage communications over the first subscription and the second subscription, the method comprising:
providing data connectivity via the first subscription associated with a data Radio Access Technology (RAT);
selecting a cell associated with the data RAT in response to determining poor channel conditions for the first subscription, wherein access to the selected cell is allowed by the second subscription associated with the second SIM and is forbidden by the first subscription associated with the first SIM; and
acquiring the selected cell allowed by the second subscription to continue the data connectivity via the data RAT on the second subscription.

27. The method of claim 26, further comprising enabling voice connectivity on the first subscription.

28. The method of claim 27, wherein enabling the voice connectivity on the first subscription comprises performing at least one of Circuit Switch (CS) attach or Location Update (LU) on the first subscription.

29. The method of claim 27, further comprising simulating a Radio Link Failure (RLF) for the first subscription in response to acquiring the selected cell.

30. The method of claim 27, further comprising:
determining that the selected cell is allowed by the second subscription; and
determining that the selected cell is forbidden by the first subscription.

31. The method of claim 1, wherein acquiring the cell allowed by the second subscription comprises performing one from the group consisting of an initial attach procedure, an acquisition procedure, and a registration procedure using information stored in the second SIM.
